(19) United States
(12) Patent Application Publication
(10) Pub. No.: US 2009/0164303 A1
(43) Pub. Date: Jun. 25, 2009

(54) CUSTOMER LOYALTY DEVELOPMENT SYSTEM

(76) Inventors: Jeffrey T. Doyle, Newburyport, MA (US); Mary Beth Doyle, Newburyport, MA (US); Robert Goulart, Weston, MA (US)

Correspondence Address: FISH & RICHARDSON PC, P.O. BOX 1022, MINNEAPOLIS, MN, 55440-1022, US

(21) Appl. No.: 12/025,380

(22) Filed: Feb. 4, 2008

Related U.S. Application Data
(60) Provisional application No. 61/015,817, filed on Dec. 21, 2007.

(51) Int. Cl. G06Q 10/00

(52) U.S. Cl. 705/10

(57) ABSTRACT

Described are computer implemented techniques for developing customer loyalty by receiving customer data from a user, processing and maintaining the customer data in a relational database and producing alerts for the user based at least in part on the processed customer data. The techniques also feature accepting orders from the user for messages or gifts to be sent to customers identified in the customer data.

### CROSS-REFERENCE TO RELATED APPLICATION

This patent application claims priority to U.S. Provisional Application No. 61/015,817, which was filed on Dec. 21, 2007. U.S. Provisional Application No. 61/015,817 is hereby incorporated by reference into this patent application as if set forth herein in full.

### BACKGROUND

This patent application relates generally to customer relations management.

One method of business development is building and maintaining personalized relationships with current and potential customers. In some industries, such as the mortgage industry, businesses use direct mailings or telephone calls to establish and maintain relationships with current and potential customers. Personalized messages tend to be more effective than generic messages in attracting customers and fostering the loyalty of current customers. When a business has a large set of current and potential customers, managing the generation and distribution of personalized messages presents logistical challenges.

### SUMMARY

This patent application describes techniques such as methods, apparatus, including computer program products, and systems for managing customer loyalty development programs.

According to an aspect of the present invention, a computer implemented method for developing customer loyalty includes receiving customer data from a user, processing and maintaining the customer data in a database, producing alerts for the user based at least in part on the processed customer data and accepting orders from the user, for messages or gifts to be sent to customers identified in the customer data.

The following are embodiments within the scope of the claims.

The alerts are sent to one or more user contacts via email. The alerts are accessed by the user via a web interface that comprises a link to a listing of outstanding alerts. The method includes receiving prospect data from the user, processing and maintaining the prospect data in a database, producing alerts for the user based at least in part on the prospect data, and accepting user orders for messages or gifts to be sent to prospects identified in the prospect data. The customer data is received from the user in batches. A batch of customer data is received in the form of a file from a File Transfer Protocol server and the file is parsed by a batch server to extract customer data and store the customer data in the relational database.

The method may include generating in response to a user request, a report that summarizes activity of a plurality of accounts that are arranged in a hierarchy with the report including those accounts for which the user has been granted a level of access to information in the account based on the hierarchy. At least one user of an account is given access to information about the usage of the other user accounts. At least one account is used to select the orders that may be placed with other user accounts. At least one account is only able to access data for customers that have been assigned to that account. At least one account is used to generate alerts for other user accounts.

The method includes extracting customer data from a user's legacy system to transmit a formatted file summarizing the data and transmitting the formatted file to a batch server that parses the file and updates customer data in the relational database based on the contents of the formatted file. The method includes identifying and merging duplicate entries. The method includes updating an address by comparing the address in the relational database to the a post office listing for the customer. The method includes producing a report summarizing how many of the user's customers have different addresses listed in the post office and in the user's data.

According to an additional aspect of the invention, an apparatus including a display, rendering a graphical user interface includes a profile section that allows a user to input and edit information about itself in a relational database, a customers section that allows the user to input and edit information about the user's customers in the relational database, an alerts section that list current alerts specific to the user's customers and active loyalty management programs and an orders section that allows the user to enter or approve orders for personalized messages to be sent to the user's customers.

In addition to features of the method above, the following are embodiments within the scope of the claims.

The graphical user interface further includes a prospects section that allows the user to input and edit information about prospects in the relational database.

According to an additional aspect of the invention, a system for managing development of customer loyalty includes a relational database server that stores user data comprising customer information, a batch server that processes user input files to update relational database entries on the relational database server, and a web server that allows users to access their data and provides services including editing the user data, receiving alerts generated based at least in part on the user data, and approving orders for generation of messages and gifts for customers.

In addition to features of the method above, the following are embodiments within the scope of the claims.

The system includes a File Transfer Protocol server configured to receive user input files and pass them to the batch server. The system includes a data extraction tool that interfaces to one or more relational databases in a user network and summarizes customer data from the user relational databases in one or more files, which are formatted to allow the batch processor to parse the files.

According to an additional aspect of the invention, a computer program product tangibly stored on a machine-readable media including instructions that when executed by one or more processing devices cause the processing device to receive customer data from a user, process and maintain the customer data in a relational database, produce alerts for the user based at least in part on the customer data and accept orders for personalized messages or gifts to be sent to customers identified in the customer data.

In addition to features of the method above, the following are embodiments within the scope of the claims.

The one or more machine-readable media wherein processing and maintaining customer data in the relational database comprises updating an address by comparing the address in the relational database to the a post office listing for the customer, which is accessed through the post office website.

One or more aspects of the invention may provide one or more of the following advantages.

The techniques provide relationship management and loyalty development services to firms, e.g., in the mortgage lending business. A system implementing these techniques is referred to herein as the Customer Manager (CM). In the mortgage industry, firms have one or more agents, called loan officers, that are responsible for subsets of the firm's customers and developing new business. The CM is a scalable system for generating personalized messages or gifts for current and potential customers for the purpose of developing customer loyalty. The CM helps users such as loan officers and mortgage companies automate customer retention and marketing programs with high-quality, personalized communications & gifts that drive repeat and referral business. The techniques empower loan officers and companies to differentiate themselves with a boutique approach to communications, while providing substantial relational database management services that clean-up and remove duplicated data and verify mailing addresses data.

The techniques provide automated direct mail and gift programs over one, two, and three years that can include boutique cards, postcards or a mix of both. The programs are tied to a transaction (usually a loan) that acts in appreciation of business on behalf of a loan officer and strives to maintain contact with the customer for future business. For each user, an image library is maintained to be used on their cards and postcards for customers that reflect the colors of their brand, i.e., “natural branding” and compose messaging based on relationship-building and market conditions. The combination of these factors makes each program unique to each user. The default mailing timing for these programs is on a quarterly basis (every 90 days) but can be customized for different intervals based on user's requirements. A partner or referral source can be listed on each mail piece that allows for co-marketing opportunities and greater partner loyalty.

Aspects of the techniques remove duplications of any records received from a user on an ongoing basis. Each new record added is compared to existing names and duplicates are eliminated. In a third aspect, the techniques verify the mailing address via the United States Postal Service's (USPS's) National Change of Address (NCOA) relational database. The techniques is automatically incorporate any new address updates that people have filed with the USPS into the relational database. The techniques may be used to generate reports based on geographic, contact type or transaction information, i.e. how many customers currently on a fixed rate mortgage with an interest rate over 8%. These reports may be distributed to users via e-mail or other communication channels.

The techniques may include receiving automated feeds from users that contain the previous month's transaction history, past customer information, privacy settings for each customer, and partner/prospect information. These feeds may be sent via file transfer protocol (FTP), through the web portal, or other communication channels.

The techniques provide a user configurable alert system that is driven based upon internal data and external data and integrated into the marketing functionality. For example, internal data shows birthdates in November and drives users to an On-Demand Birthday Card program, external data points out customers with high interest rates and drives users to a different mailing program.

Data may be presented to users via a web interface that includes a “Dashboard” single-view reporting to show loan, marketing, order and alert activity summaries on a single page. The techniques may provide a hierarchical-driven reporting system based upon corporate and user settings, where the reports are produced using dynamic Structured Query Language (SQL) that ties into the marketing programs. Client managerial reporting shows alert utilization of accounts of client agents who are lower in a corporate hierarchy to client agents who are relatively higher in the corporate hierarchy.

The foregoing technique(s) may be implemented as a computer program product comprised of instructions that are stored on one or more machine-readable media, and that are executable on one or more processing devices. The foregoing technique(s) may be implemented as an apparatus or system that includes one or more processing devices and memory to store executable instructions to implement the technique.

The details of one or more examples are set forth in the accompanying drawings and the description below. Further features, aspects, and advantages of the invention will become apparent from the description, the drawings, and the claims.

### DESCRIPTION OF DRAWINGS

FIG. 1 is a block diagram of a client system connected to a CM via the Internet.

FIG. 2 is a block diagram of a client system uploading data into a CM relational database 12 through an FTP server that is connected to a batch processing server.

FIG. 3 is a block diagram of data extraction tools used at firm's site to extract customer data from the firm's data sources and transmit the extracted data in formatted files to a CM.

FIG. 4 is a block diagram of corporate client accessing a CM over the Internet with multiple accounts which each have different status in a corporate hierarchy.

FIG. 5 shows a graphical user interface served from the CM web server that allows a firm to input and access data view alerts and reports and place orders for messages or gifts to customers.

FIG. 6 shows a graphical user interface served from the CM web server that allows a firm to input data for individual contacts.

### DETAILED DESCRIPTION

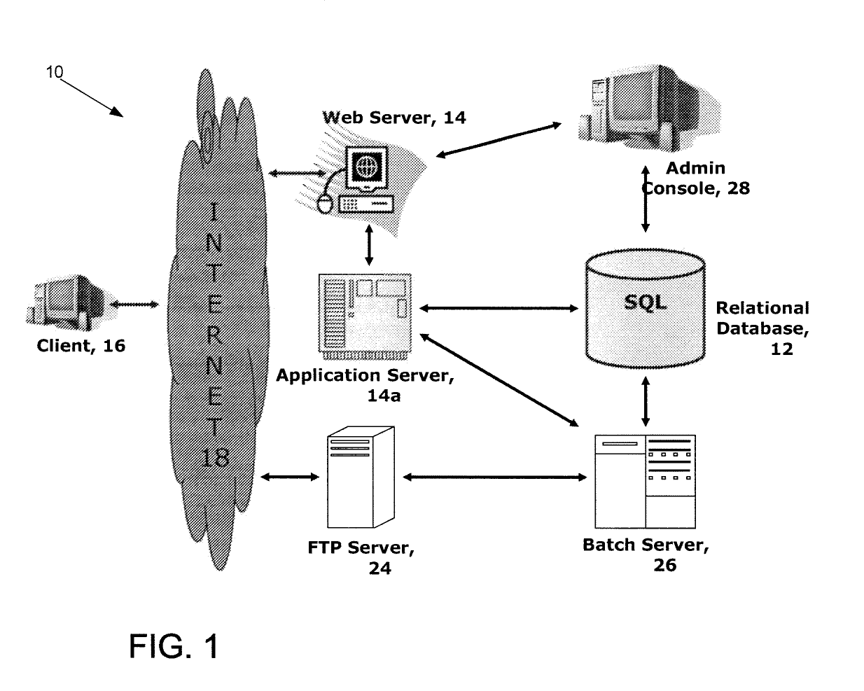

Referring to FIG. 1, a customer management system (CM) system 10 includes a relational database 12 and one or more web servers 14 that allow client systems 16 to access data in the relational database 12 over a network such as the Internet 18. A client system 16 is used by a user at a firm, e.g., a loan officer at a mortgage lender. The user has one or more accounts that allow the user to access the CM 10 through a web interface served by web server 14. Each account has a login and password that allow for secure access to the data associated with that account. Encryption may be used to secure the link between the web servers 14 and the client terminal, such as the Secure Sockets Layer (SSL) protocol. Once logged in, the user may access its data through a graphical user interface served by the web server. The user may also download reports or log files that summarize data or activity on the account.

The user may input new data to the CM 10. Data is entered manually by typing data into fields of the graphical user interface. Alternatively, data is inputted in formatted files that the user uploads to the web server. The web interface may allow the user to view alerts produced by the CM 10 or an external source. Alerts may also be sent to user contacts via email or other like approaches. The web interface allows a client to place or approve orders for messages or gifts to be sent to contacts stored in the relational database 12, such as customers or prospects. The web servers 14 may be implemented in software running on an application server 14a.

The CM 10 also includes one or more batch servers 26 that are configured to process formatted input files to extract data, such as customer data, and store the extracted data in the relational data base. The CM 10 also includes one or more FTP servers 24 for transferring input data files from the client system 16 to a batch server 26 and transferring reports or log files to the client system 16. The CM 10 may also include one or more administration consoles 28 that allow an administrator to configure the system and monitor its performance.

In the loan industry users will provide automated feeds to the system and users that are loan officers, for example, will log-in and review closed loan information and approve orders. Users such as loan officers may also place orders via e-mail or fax. Users can respond to alerts and place orders based on alerts, produce reports on their contact or loan information, place on-demand orders, such as birthday cards or product-specific cards, and update their personal contact information. For any loan officer that has another loan come into the system, a default second offering, for example, a gift instead of card program, may be automatically setup to be fulfilled. Depending on the loan type, the address for any mailing is dynamically produced. For example, mailing address for investment properties and property address for home purchases.

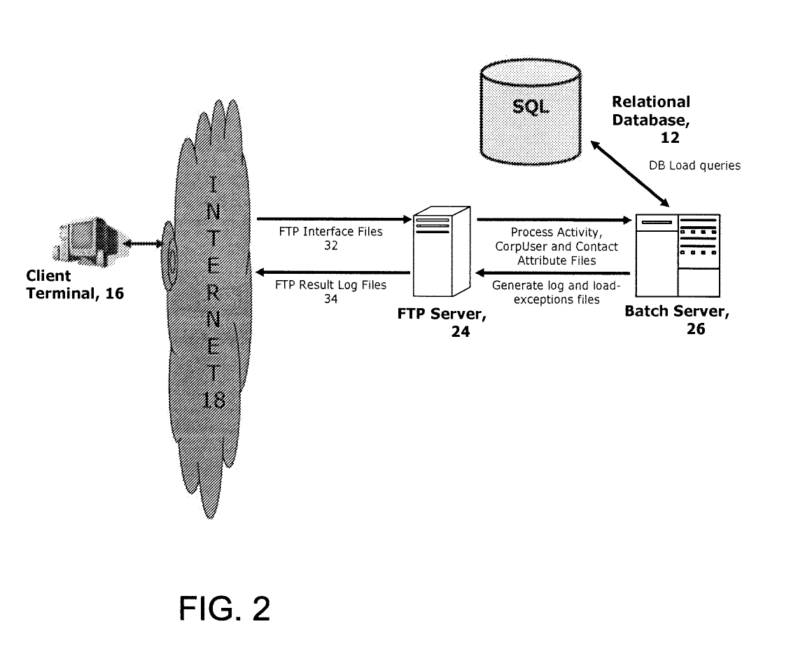

Referring to FIG. 2, a user uploads data, such as customer data, to the CM 10 relational database 12 by sending a formatted data file to a CM 10 FTP server 24. These formatted data files are referred to as “interface files.” The batch server 26 processes interface files that have been transferred to the FTP server 24. The batch server 26 parses the interface files and updates the CM 10 relational database 12 based on the resulting data. Updating the relational database 12 may include checking for duplicate entries in the data and either deleting or merging duplicate records in the data. The batch server 26 may record the results, possibly including errors, of a relational database 12 update based on an interface file 32 in a report or log file. The report or log file 34 is then stored on the FTP server 24 to be transferred to the client over the internet. Interface files provided by a client and result files 34, such as log and load-exceptions, generated by the batch server 26 are stored in a secure directory.

A user either provides an ftp directory that allows the system to pull the interface files 32 or the system provides users with their own unique ftp directory into which the users push their interface files 32. If a secure ftp site is not available then encryption may be performed using standard off-the-shelf encryption utilities, such as WinZip, and the appropriate encryption keys may be exchanged between a user and the CM 10 via alternate channels such as an e-mail, telephone and so forth During batch processing, the system decrypts and loads the interface files 32 in an order based upon the date/time specified in the file name. Once loading is complete, the file is moved to a backup directory and retained for a configurable period of time.

New interface files 32 may be received as the firm makes the interface files 32 available or at regular intervals. Frequency of transmissions, for example Daily, Weekly, or Monthly, are configurable based on firm needs and the load on system servers. The batch loads may be performed at night when activity on the portal is expected to be low.

Interface files 32 are transferred to the CM 10 via FTP, as depicted in FIG. 2 or uploaded through the web interface, as discussed above. The three primary types of interface files 32 are, Activity Feeds, Corporate User Feeds, and Contact Attribute Feeds. Activity Feeds include extracts from corporate loan origination or contact management systems used by a client containing information on loans, borrowers, co-borrowers, etc. Corporate User Feeds include information on the corporate hierarchy of a firm, such as loan officers and associated managers employed by the firm. Contact Attribute Feeds support updating contact-level attributes, such as “Do Not Mail” setting, and transmission of contact-level alerts.

The Interface files 32 are standard tab-delimited files with tabs separating the columns and carriage returns separating the records. All fields may also be delimited by quotes. In this embodiment, no extra tabs or quotes may be contained within the data columns transmitted and no extra carriage returns will be contained within each row of information. Other arrangements are possible.

Where possible, the CM 10 stores domain attributes for transactions, users and contacts in a list format vs. free-form text. That is, the list of possible values for that data attribute are predefined. This approach enhances the ability of the CM 10 to analyze the data consistently while also increasing system performance and reducing storage requirements. The CM 10 is configured to handle varying ranges-of-values for specific data attributes, such as Types of Transactions and Amortization types. This capability allows the CM 10 to adapt to the data requirements of individual firms.

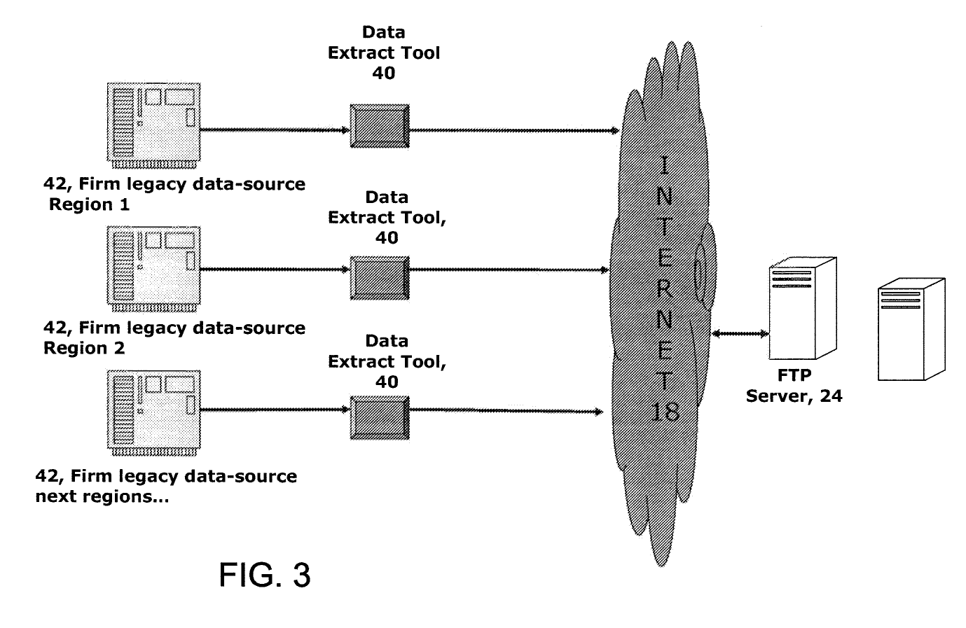

Referring to FIG. 3, one or more data extraction tools 40 may be deployed in firm networks to facilitate seamless integration with the firm's existing data management systems 42. A data extraction tool 40 is tailored to interface with a particular firm data source, such as loan origination software. The data extraction tool 40 collects data from the firm data source 42 and records it in interface files. The resulting interface files 32 are transmitted to the CM 10 either upon user request or automatically in response to events or in accordance with a schedule. The files may be sent to the CM 10 via its 24 server. The data extraction tool 40 is implemented as software that runs on a firm's system 42. In this manner, the firm can exert more control over the firm's raw data. In another embodiment (not shown), the data extraction tool 40 is implemented on a stand-alone hardware device that is connected to the firm's corporate network.

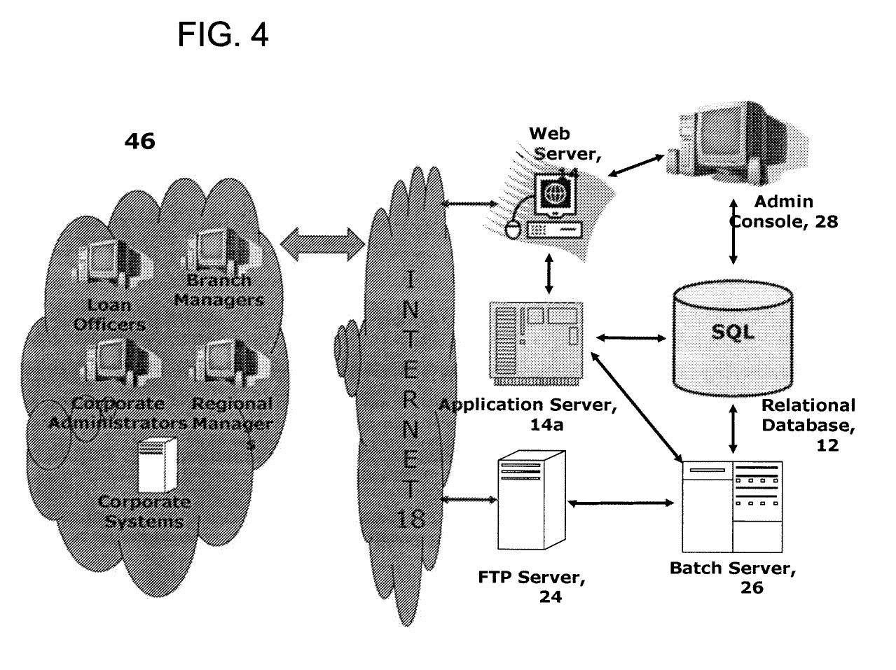

Referring to FIG. 4, some firms may be corporations with multiple agents who require different levels of access to the firm data stored in the CM 10. For example, a firm in the lending business may have “loan officers” that work directly with customers and prospects to issue loans. Such a firm may also have one or more levels of “management” such as “branch managers,” “regional managers,” “corporate administrators,” and so forth, above the loan officers. This corporate hierarchy may be distributed across different geographic regions of functional divisions.

The CM 10 is configured to fit the corporate hierarchy (generally denoted by 46) of the firm by issuing multiple accounts to functions/individuals in the firm. Each individual may be given its own account with access privileges appropriate for its function. For example, individual loan officers are given accounts that only allow them to access customer data and prospect data for customers and prospects that the loan officers inputs or that are assigned to the loan officer from another client account. Loan officers may only receive alerts that are relevant to the customers and prospects they have been assigned. A manager may be issued an account with access to data for customers assigned to the group managed by that person, and so on.

Management accounts may also be configured to generate reports on the activity of other CM 10 accounts of the firm. For example a management account may be configured to produce reports that that tell the manager whether and when other accounts have been used at all or whether alerts to those accounts have been responded to. Management accounts may also be configured to select what types of orders may be placed by other accounts.

Accounts may also be allowed to generate alerts for other accounts. A hierarchy may be used to determine which accounts are authorized to send alerts to which other accounts.

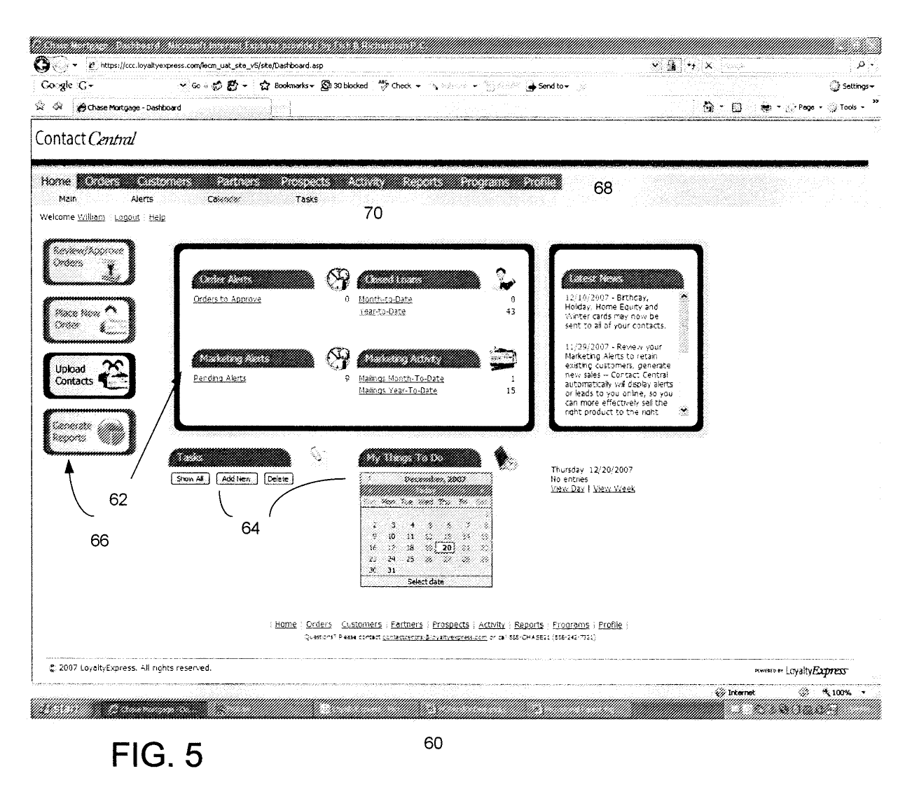

Referring to FIG. 5, a user accesses the CM 10 via a graphical user interface 60 that is served by the web server. The graphical user interface 60 includes areas where users can view pending alerts 62 and other status summary information, such as a task list or recent activity summary. The user easily links 66 to other screens for data entry, placing or approving orders, and various reports. The display includes a menu with a number of tabs 68 and sub-tabs 70 that allow the client to easily navigate the graphical user interface.

The CM 10 produces numerous reports that are accessed through web-based graphical user interface. The reports summarize client data in several ways. For example, reports are produced to indicate how many orders are placed each month; how many loan officers login or do not login broken down by branch, region, or division; loan and customer attribute-specific reports for loan officers; how many loan officers did not click on/open alerts; or assignment of customers/book of business from one loan officer to many within same branch. Access to reports may be limited information based on a hierarchy of firm accounts.

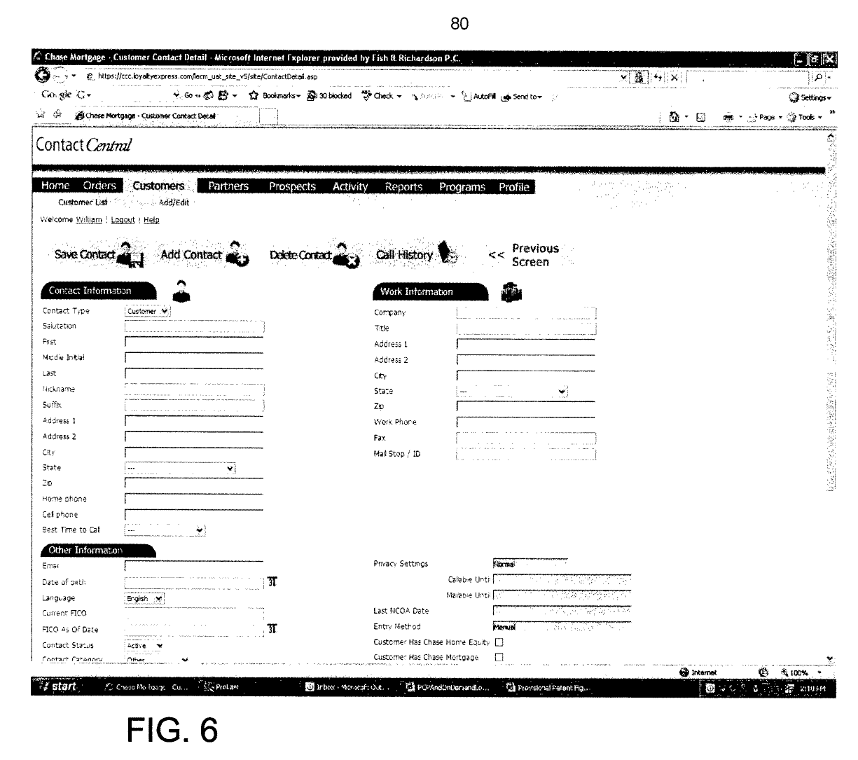

Referring to FIG. 6, users may manually enter data through the web interface by typing data into fields of the graphical user interface, as shown in this example data-entry screen 80. Some fields may be limited to a small set of possible values that selected from drop-down menus.

In one embodiment, each company loan officer submits their past customer information, either through the web interface or through a back-end data entry mechanism such as transferring interface files 32 via FTP. The CM 10 removes duplicate data, and verifies mailing addresses by cross-referencing the mailing addresses with a post office relational database (not shown). A result of this process is a report, “LoyaltyScorecard” that provides the submitter a report that shows how many customer addresses have changed in the last four years, how many addresses are undeliverable, and how many addresses have remained the same. Address verification improves the efficacy of loyalty programs and helps save postage costs. For loyalty programs in the mortgage space it can also reveal how many loans have been lost by the number of people that have moved on without the firm's knowledge.

The techniques described provide multiple relational database 12 services to loan officers and firms. Many loan officers just have paper records of their past customers The techniques allow the production of a relational database 12 for each firm that can record fields of personal and transaction information of that firm's customers. Partner/referral information that is associated with a loan can also be recorded as well as relational database 12 sub-sections to handle Partner and Prospect relational database 12s. The techniques essentially keep a comprehensive version of a firm's contacts and transaction information on an ongoing basis.

The invention can be implemented in digital electronic circuitry, or in computer hardware, firmware, software, or in combinations thereof. Apparatus of the invention can be implemented in a computer program product tangibly embodied in a machine-readable storage device for execution by a programmable processor; and method actions can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Such a computer includes a processor, random access memory (RAM), program memory (for example, a writable read-only memory (ROM) such as a flash ROM), a hard drive controller, and an input/output (I/O) controller coupled by a processor (CPU) bus. The hard drive controller is coupled to a hard disk suitable for storing executable computer programs, including programs embodying the present invention, and data including storage. Browsers can be Microsoft Internet Explorer or Netscape Communicator or other types.

A number of embodiments of the invention have been described. Nevertheless, it will be understood that various modifications may be made without departing from the spirit and scope of the invention. Accordingly, other embodiments are within the scope of the following claims.

What is claimed is:

1. A computer implemented method for developing customer loyalty, the method comprising:
receiving customer data from a user;
processing and maintaining the customer data in a database;
producing alerts for the user based at least in part on the processed customer data; and
accepting orders, from the user, for messages or gifts to be sent to customers identified in the customer data.

2. The method of claim 1, wherein the alerts are sent to one or more user contacts via email.

3. The method of claim 1, wherein the alerts are accessed by the user via a web interface that comprises a link to a listing of outstanding alerts.

4. The method of claim 1, further comprising:
receiving prospect data from the user;
processing and maintaining the prospect data in a database;
producing alerts for the user based at least in part on the prospect data; and
accepting orders, from the user, for messages or gifts to be sent to prospects identified in the prospect data.

5. The method of claim 1, wherein customer data is received from the user in batches.

6. The method of claim 5, wherein a batch of customer data is received in the form of a file from a File Transfer Protocol server and the file is parsed by a batch server to extract customer data and store the customer data in the relational database.

7. The method of claim 1, further comprising:
generating in response to a user request, a report that summarizes activity of a plurality of accounts that are arranged in a hierarchy with the report including those accounts for which the user has been granted a level of access to information in the account based on the hierarchy.

8. The method of claim 7, wherein at least one user account is given access to information about the usage of one or more other user accounts.

9. The method of claim 7, wherein at least one account is used to select the orders that may be placed with other user accounts.

10. The method of claim 7, wherein at least one account is only able to access data for customers that have been assigned to that account.

11. The method of claim 7, wherein at least one account is used to generate alerts for other user accounts.

12. The method of claim 5, further comprising:
extracting customer data from a user's legacy system to transmit a formatted file summarizing the data
transmitting the formatted file to a batch server that parses the file and updates customer data in the relational database based on the contents of the formatted file.

13. The method of claim 1, wherein processing and maintaining customer data in the relational database comprises
identifying and merging duplicate entries.

14. The method of claim 1, wherein processing and maintaining customer data in the relational database comprises
updating an address by comparing the address in the relational database to the a post office listing for the customer.

15. The method of claim 1, further comprising producing a report summarizing how many of the user's customers have different addresses listed in the post office and in the user's data.

16. An apparatus comprising a display, rendering a graphical user interface comprising:
a profile section that allows a user to input and edit information about itself in a relational database;
a customers section that allows the user to input and edit information about the user's customers in the relational database;
an alerts section that list current alerts specific to the user's customers and active loyalty management programs; and
an orders section that allows the user to enter or approve orders for personalized messages to be sent to the user's customers.

17. The apparatus of claim 16, wherein the graphical user interface further comprises a prospects section that allows the user to input and edit information about prospects in the relational database.

18. A system for managing development of customer loyalty comprising:
a relational database server that stores user data comprising customer information;
a batch server that processes user input files to update relational database entries on the relational database server; and
a web server that allows users to access their data and provides services comprising:
editing the user data;
receiving alerts generated based at least in part on the customer data; and
approving orders for generation of messages and gifts for customers.

19. The system of claim 18, further comprising a File Transfer Protocol server configured to receive user input files and pass them to the batch server.

20. The system of claim 18, further comprising a data extraction tool that interfaces to one or more relational databases in a user network and summarizes customer data from the user relational databases in one or more files, which are formatted to allow the batch processor to parse the files.

21. A computer program product tangibly stored on a machine-readable media comprising instructions that when executed by one or more processing devices cause the processing device to:
receive customer data from a user;
process and maintain the customer data in a relational database;
produce alerts for the user based at least in part on the customer data; and
accept orders for personalized messages or gifts to be sent to customers identified in the customer data.

22. The one or more machine-readable media of claim 21, wherein processing and maintaining customer data in the relational database comprises updating an address by comparing the address in the relational database to the a post office listing for the customer, which is accessed through the post office website.
